(19) United States
(12) Patent Application Publication
(10) Pub. No.: US 2025/0079471 A1
(43) Pub. Date: Mar. 6, 2025

(54) CELL

(71) Applicant: TOYOTA JIDOSHA KABUSHIKI KAISHA, Toyota-shi (JP)

(72) Inventor: Shinya SHIOTANI, Nagoya-shi (JP)

(73) Assignee: TOYOTA JIDOSHA KABUSHIKI KAISHA, Toyota-shi (JP)

(21) Appl. No.: 18/743,105

(22) Filed: Jun. 14, 2024

(30) Foreign Application Priority Data
Sep. 4, 2023 (JP) 2023-143131

(51) Int. Cl. H01M 4/66; H01M 4/02

(52) U.S. Cl. CPC H01M 4/667; H01M 2004/027

(57) ABSTRACT

The present disclosure provides a cell using a deposition-dissolution reaction of metallic lithium as an anode reaction. The cell includes: a cathode including a cathode current collector and a cathode active material layer; an anode including at least an anode current collector; and an electrolyte layer disposed between the cathode and the anode. The anode current collector is a resin current collector. The anode includes a first metal layer between the anode current collector and the electrolyte layer, the first metal layer containing either or both of Mg and Ag.

### CROSS-REFERENCE TO RELATED APPLICATION

This application claims priority to Japanese Patent Application No. 2023-143131 filed on Sep. 4, 2023, incorporated herein by reference in its entirety.

### BACKGROUND

### 1. Technical Field

The present disclosure relates to cells.

### 2. Description of Related Art

A cell typically includes an electrolyte layer between a cathode active material layer and an anode active material layer. Cells using a deposition-dissolution reaction of metallic lithium as an anode reaction are known in the field of cells. For example, Japanese Unexamined Patent Application Publication No. 2016-035867 (JP 2016-035867 A) discloses that, in a solid-state lithium secondary cell including an anode current collector, a solid electrolyte layer, a cathode active material layer, and a cathode current collector in this order, copper (Cu), a metal that is not alloyed with lithium (Li), is used as a material of the anode current collector.

### SUMMARY

In cells using a deposition-dissolution reaction of metallic lithium as an anode reaction, an anode active material layer (layer containing anode active material particles) is usually not provided at the time of manufacturing the cells, and an anode active material layer (layer containing Li) is formed by initial charge. Therefore, such cells are advantageous in that the manufacturing process can be easily simplified and the energy density per volume can be easily improved. The use of a resin anode current collector (resin current collector) as an anode current collector has been considered from the viewpoint of improving the energy density per weight.

Since resin current collectors are lighter than metal current collectors, the cell weight can be reduced. However, since resin current collectors have lower electron conductive properties than metal current collectors, the use of resin current collectors may reduce the Coulombic efficiency.

The present disclosure was made in view of the above circumstances, and a primary object of the present disclosure is to provide a cell that can achieve a high Coulombic efficiency while reducing the cell weight.

A cell using a deposition-dissolution reaction of metallic lithium as an anode reaction includes:
a cathode including a cathode current collector and a cathode active material layer; an anode including at least an anode current collector; and an electrolyte layer disposed between the cathode and the anode.

The anode current collector is a resin current collector.

The anode includes a first metal layer between the anode current collector and the electrolyte layer, the first metal layer containing either or both of magnesium (Mg) and silver (Ag).

In the above cell,
the anode may include a second metal layer between the anode current collector and the first metal layer, the second metal layer containing either or both of nickel (Ni) and copper (Cu).

In the above cell,
the anode current collector and the first metal layer may constitute a coated current collector.

In the above cell,
the first metal layer may contain Li.

In the above cell,
the first metal layer may not contain Li.

In the above cell,
the electrolyte layer may be a solid electrolyte layer containing a solid electrolyte.

The cell according to the present disclosure is advantageous in that it can achieve a high Coulombic efficiency while reducing the cell weight.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a cell according to the present disclosure; and

FIG. 2 is a schematic cross-sectional view illustrating a cell in the present disclosure.

### DETAILED DESCRIPTION OF EMBODIMENTS

Hereinafter, a cell in the present disclosure will be described in detail with reference to the drawings. Each drawing shown below is schematically shown, and the size and shape of each part are appropriately exaggerated for easy understanding.

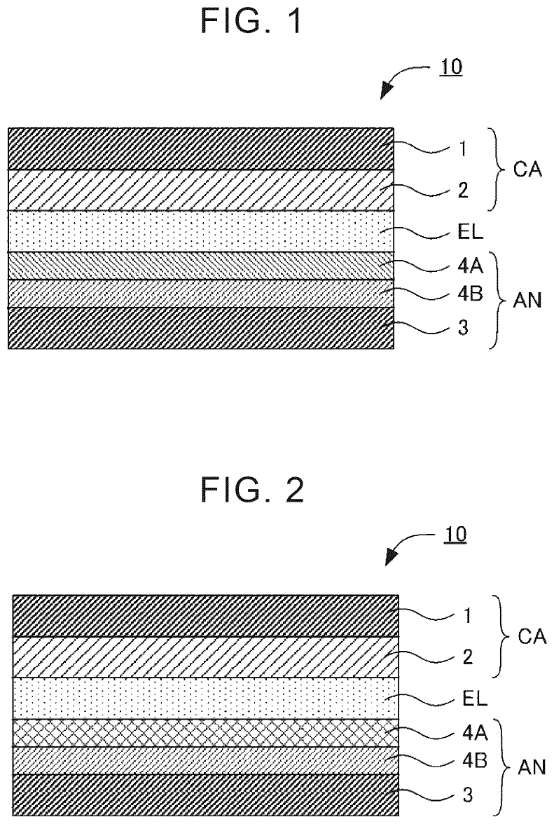

FIG. 1 and FIG. 2 are schematic cross-sectional views illustrating a cell in the present disclosure. More specifically, FIG. 1 illustrates the cell before the initial charge, and FIG. 2 illustrates the cell after the initial charge. As shown in FIGS. 1 and 2, the cell 10 includes a cathode CA having a cathode current collector 1 and a cathode active material layer 2, an anode AN having at least an anode current collector 3, and an electrolyte layer EL disposed between the anode AN and the cathode CA. The anode current collector 3 is a resin current collector. Here, as shown in FIG. 1, in the cell 10, the anode AN has a first metal layer 4A that contains either or both of Mg and Ag between the anode current collector 3 and the electrolyte layer EL. The anode AN has a second metal layer 4B containing either or both of Ni and Cu between the anode current collector 3 and the first metal layer 4A. Further, as shown in FIG. 1, in the cell 10 prior to the first charge, the first metal layer 4A usually does not contain Li. On the other hand, as shown in FIG. 2, in the cell 10 after the initial charge, the first metal layer 4A usually contains Li.

According to the present disclosure, since the anode includes the resin current collector and the first metal layer containing a predetermined metal, it is possible to obtain a good Coulomb efficiency while achieving weight reduction. As described in JP 2016-035867 A, it is known to use a metallic current collector such as Cu as an anode current collector. Since the metal current collector has a high density, the energy density per weight is reduced. In contrast, in the present disclosure, a resin current collector is used as the anode current collector. Since the resin current collector is lighter in weight than the metal current collector, the energy density per weight can be improved.

Here, as shown in a comparative example to be described later, there is a concern that when a resin current collector is used, the Coulombic efficiency is lower than when a metal current collector is used. This is presumably because the resin current collector has lower electronic conductivity than the metal current collector. In contrast, the anode includes a first metal layer containing either or both of Mg and Ag between the current collector and the electrolyte layer. Typically, the resin current collector is coated with the first metal layer to form a coated current collector. By providing the first metal layer, good electron conductivity can be obtained. Furthermore, Mg and Ag contained in the first metal layer can be alloyed with Li and have no solubility limits, respectively. Therefore, Li can be stored satisfactorily at the time of charge. Therefore, it is presumed that good Coulombic efficiency can be obtained even when a resin current collector is used.

### Anode

The anode in the present disclosure includes at least an anode current collector. In the present disclosure, the anode current collector is a resin current collector. As shown in FIG. 1, the anode AN has a first metal layer 4A containing either or both of Mg and Ag between the anode current collector 3 and the electrolyte layer EL. As shown in FIG. 1, the anode AN may have a second metal layer 4B between the anode current collector 3 and the first metal layer 4A. On the other hand, although not particularly shown, it is preferable that the anode does not have an anode active material layer containing anode active material particles.

### Anode Current Collector

The anode current collector in the present disclosure is a resin current collector. The resin current collector means a current collector containing a resin as a main material. The ratio of the resin to all the components constituting the resin current collector is, for example, 50% by weight or more, may be 60% by weight or more, may be 70% by weight or more, may be 80% by weight or more, may be 90% by weight or more, or may be 95% by weight or more. On the other hand, the ratio of the resin is usually less than 100% by weight.

Examples of the resin used in the resin current collector include thermoplastic resins. Examples of the thermoplastic resins include polyolefins such as polyethylene (PE) and polypropylene (PP).

The resin current collector usually contains a conductive material. Examples of the conductive material include a carbon material. Examples of the carbon material include particulate carbon materials such as acetylene black (AB) and Ketjen black (KB); and fibrous carbon materials such as carbon fibers, carbon nanotubes (CNT), and carbon nanofibers (CNF). The proportion of the conductive material in the resin current collector is, for example, 5 wt % or more and 50 wt % or less.

The thickness of the resin current collector is not particularly limited, but is, for example, 1 μm or more and 500 μm or less.

### First Metal Layer

The first metal layer in the present disclosure is disposed closer to the electrolyte layer than the anode current collector. The first metal layer contains either or both of Mg and Ag. The first metal layer may contain Mg metal (Mg alone), may contain Mg alloy (alloy containing Mg as a main component), may contain Ag metal (Ag alone), or may contain Ag alloy (alloy containing Ag as a main component). The metal other than Mg in Mg alloy is preferably a metal alloyed with lithium. Examples of such a metal include Zn, Al. The same applies to metals other than Ag in Ag alloy.

The first metal layer in the present disclosure is preferably in close contact with the anode current collector. This is because the electron conductivity is improved. That is, the first metal layer is preferably disposed so as to cover the surface of the anode current collector. In the present disclosure, a member including an anode current collector and a first metal layer disposed on the anode current collector may be referred to as a coated current collector. In the coated current collector, the first metal layer may be directly disposed on the anode current collector or may be disposed via another layer. Examples of the other layer include a second metal layer described later.

The first metal layer is, for example, a thin film, and is preferably a vapor-deposited film. The thickness of the first metal layer is not particularly limited, but is, for example, 30 nm or more. On the other hand, the thickness of the first metal layers may be, for example, less than or equal to 1000 nm, less than or equal to 800 nm, or less than or equal to 500 nm. The first metal layer can be formed by, for example, a vapor deposition method such as vacuum deposition.

The first metal layers may not contain Li, or may contain Li. The former corresponds to, for example, the state of the first metal layer in the cell before the initial charge, and the latter corresponds to, for example, the state of the first metal layer in the cell after the initial charge. As shown in FIG. 2, when Li is introduced into the first metal layer 4A by the first charge, the metal (Mg, Ag) contained in the first metal layer is alloyed with Li. For example, an alloy phase such as a Mg—Li alloy phase or an Ag—Li alloy phase is formed in the first metal layer. During discharging, Li moves from the first metal layer alloyed with Li toward the cathode. Further, although not particularly shown, a Li phase may be formed inside the first metal layer 4A by charge. Similarly, a deposited Li layer may be formed between the first metal layer and the electrolyte layer by charge. Similarly, a deposited Li layer may be formed between the first metal layer and the anode current collector by charge.

### Second Metal Layer

The anode may include a second metal layer located between the anode current collector and the first metal layer and containing either or both of Ni and Cu.

The second metal layer may contain Ni metal (Ni alone), may contain Ni alloy (alloy mainly containing Ni), may contain Cu metal (Cu alone), or may contain Cu alloy (alloy mainly containing Cu). Ni and Cu are metals that do not alloy with Li. The second metal layer is typically a layer that is not alloyed with Li. Even when the first metal layer is alloyed with Li and, for example, the first metal layer is changed in form, the second metal layer that is not alloyed with Li functions as a buffer layer, so that the electronic conduction paths between the first metal layer and the anode current collector are favorably maintained.

The second metal layer is, for example, a thin film, and is preferably a vapor-deposited film. The thickness of the second metal layer is not particularly limited, but is, for example, 30 nm or more. On the other hand, the thickness of the second metal layer may be, for example, less than or equal to 1000 nm, less than or equal to 800 nm, or less than or equal to 500 nm.

### Cathode

The cathode in the present disclosure includes a cathode current collector and a cathode active material layer.

The cathode active material layer contains at least a cathode active material. The cathode active material layer may contain at least one of the following: an electrolyte, a conductive material, and a binder.

Examples of the cathode active material include an oxide active material. Examples of the oxide active material include rock salt-type layered active materials such as LiCoO₂, LiNi_{1/3}Co_{1/3}Mn_{1/3}O₂, spinel-type active materials such as LiMn₂O₄, Li₄Ti₅O₁₂, and olivine-type active materials such as LiFePO₄.

The same description as in “1. Anode” applies to the conductive material. The same description as in “3. Electrolyte Layer” applies to the electrolyte layer. Examples of the binder include rubber-based binders such as butylene rubber (BR) and styrene-butadiene rubber (SBR), and fluoride-based binders such as polyvinylidene fluoride (PVDF).

Examples of material for the cathode current collector include stainless steel (SUS), aluminum, nickel, and carbon. Examples of the shape of the cathode current collector include a foil shape. The thickness of the cathode current collector is, for example, 1 μm or more and 500 μm or less.

### Electrolyte Layer

The electrolyte layer contains at least an electrolyte. In addition, the electrolyte layer may contain a binder.

Examples of the electrolyte include a solid electrolyte. Examples of the solid electrolyte include inorganic solid electrolytes such as a sulfide solid electrolyte, an oxide solid electrolyte, and a halide solid electrolyte. The sulfide solid electrolyte preferably contains sulfur(S) as a main component of the anionic element. The oxide solid electrolyte preferably contains oxygen (O) as a main component of the anionic element. The halide solid electrolyte preferably contains halogen (N) as a main component of the anion. Among these, a sulfide solid electrolyte is preferable.

Examples of the sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCI, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any of Ge, Zn, and Ga), Li₂S—GeS₂, Li₂S—SiS₂—Li₃PO₄, Li₂S—SiS₂-LiₓMO_{y} (where x and y are positive numbers, and M is any of P, Si, Ge, B, Al, Ga, and In).

Other examples of solid electrolytes include organic solid electrolytes such as polymer electrolytes and gel electrolytes. As the electrolyte, a liquid electrolyte (electrolytic solution) can also be used. In the present disclosure, an electrolyte layer containing a solid electrolyte may be referred to as a solid electrolyte layer, and a cell having a solid electrolyte layer may be referred to as an all-solid-state cell. The same description as in “2. Cathode” applies to the binder. The thickness of the electrolyte layer is, for example, 1 μm or more and 500 μm or less.

In the cell, the solid electrolyte layer may be in direct contact with the first metal layer. On the other hand, in the all-solid-state cell, another layer may be disposed between the solid electrolyte layer and the first metal layer. Other layers include protective layers that contain Sn and protect the solid electrolyte layer. The protective layers may contain Sn metal (Sn alone) or Sn alloy (alloy containing Sn as a main component). Instead of Sn, Au or Al may be used. The protective layer is, for example, a thin film, and is preferably a vapor-deposited film. The thickness of the protective layers is not particularly limited, but is, for example, 30 nm or more. On the other hand, the thickness of the protective layers may be, for example, less than or equal to 1000 nm, less than or equal to 800 nm, or less than or equal to 500 nm. The protective layer can be formed by, for example, a sputtering method.

### Cell

Applications of the cell of the present disclosure are not particularly limited, and examples thereof include power sources of vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Further, the cell may be used as a power source for a moving object (for example, a railway, a ship, or an aircraft) other than the vehicle, or may be used as a power source for an electric product such as an information processing apparatus.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

### Preparation of Resin Current Collector

A resin slurry was obtained by mixing a resin (polyethylene), a conductive material (acetylene black), and a solvent (butyl butyrate). The resulting resin-slurry was applied to PET films by a blade method using an applicator. It was dried on a hot plate at 50° C. for 20 minutes and then further dried on a hot plate at 150° C. for 30 minutes. Then, PET films were peeled off, and a resin current collector (anode current collector) with a thickness of 30 μm was obtained.

### Preparation of Coated Current Collectors

A Mg layer (first metal layer) having a thickness of 1000 nm was formed on the surface of the obtained resin-based current collector by a vapor deposition method to obtain a coated current collector.

### Preparation of Solid Electrolyte Layer

As a sulfide solid electrolyte, LiI-containing Li₂S—P₂S₅ based glass-ceramics were prepared. Sulfide solids electrolytes and binders (5 wt % heptane solutions of PVdF based binders) were added to heptane and stirred using an ultrasonic disperser for 30 seconds. After stirring, the slurry was prepared by shaking for 30 minutes. The prepared slurries were applied to PET films by a blade method using applicators. It was allowed to dry naturally and then dried on a hot plate at 100° C. for 30 minutes. As a result, solid electrolyte layers were obtained on PET films. The resulting two solid electrolyte layers were laminated and pressed at 7 ton/cm². After pressing, PET films were peeled off to obtain self-supporting solid electrolyte layers. Thereafter, an Sn layer with a thickness of 100 nm was formed on one side of the solid electrolyte layer by a sputtering method.

### Preparation of Cathode

A solvent (butyl butyrate), a binder (a 5 wt % butyl butyrate solution of a PVdF binder), a cathode active material (lithium nickel cobalt aluminum oxide), and a conductive material were added to PP container. Further, the sulfide solid electrolyte was added so that the volume ratio of the cathode active material to the sulfide solid electrolyte was 75:25. Thereafter, PP container was stirred for 30 seconds using an ultrasonic dispersing device (UH-50 manufactured by SMT). Next, PP container was shaken with a shaker (TTM-1, manufactured by Shibata Science Co., Ltd.) for 30 minutes. Thus, a cathode slurry was obtained. The obtained cathode slurry was coated on a cathode current collector (Al foil) by a blade method. This was then allowed to dry naturally and then dried on a hot plate at 100° C. for 30 minutes. Thus, a cathode having a cathode current collector and a cathode active material layer was obtained.

### Preparation of Evaluation Cells

The coated current collector and the solid electrolyte layer were each punched into Φ14.5 mm. Next, a solid electrolyte layer was disposed on the coated current collector such that Mg layer and Sn layer were opposed to each other. Further, a stack was obtained by stacking an anode punched into Φ11.28 mm so that the solid electrolyte layer and the cathode active material layer face each other. A cathode terminal and an anode terminal were connected to the laminated body, and the laminated film was sandwiched and welded. The laminated films were subjected to CIP treatment under a pressure of 392 MPa. As a result, an evaluation cell was manufactured.

### Example 2

An evaluation cell was prepared in the same manner as in Example 1, except that a Ni layer (second metal layer) with a thickness of 1000 nm was formed by a sputtering method prior to forming Mg layer (first metal lowne) on the surface of the resin current collector.

### Comparative Example 1

An evaluation cell was prepared in the same manner as in Example 1, except that a resin current collector (a resin current collector without a metal layer) was used instead of the coated current collector.

### Comparative Example 2

An evaluation cell was prepared in the same manner as in Example 1, except that a Ni foil (metallic current collector) was used instead of the coated current collector.

### Comparative Example 3

An evaluation cell was produced in the same manner as in Example 1 except that a coated metal current collector in which an Mg layer with a thickness of 1000 nm was formed on Ni foil (metal current collector) by a sputtering method was used instead of the coated current collector.

### Evaluation

The evaluation cells prepared in each example and each comparative example were restrained on a metal plate with a pressure of 1 MPa. A charge/discharge test was performed on these evaluation cells at 60° C. in CCCV mode at 3 V to 4.2 V, and 0.15 mA/cm² (0.03 mA/cm² cut). Coulomb efficiency was calculated from the charge capacity and the discharge capacity. The results are shown in Table 1.

TABLE 1

| | | | | | Discharge | Coulombic |
|---|---|---|---|---|---|---|
| | Anode | Metal Layer | | Charge Capacity | Capacity | Efficiency |
| | Assembly | First | Second | (mAh/g) | (mAh/g) | (%) |
| Comparative | Resin | — | — | 180 | 100 | 55.6 |
| Example 1 | | | | | | |
| Comparative | Metal | — | — | 195 | 160 | 82.1 |
| Example 2 | (Ni foil) | | | | | |
| Comparative | Metal | Mg | — | 199 | 170 | 85.4 |
| Example 3 | (Ni foil) | | | | | |
| Example 1 | Resin | Mg | — | 204 | 175 | 85.8 |
| Example 2 | Resin | Mg | Ni | 200 | 178 | 89.0 |

As shown in Table 1, Comparative Example 1 and Comparative Example 2 showed that the Coulomb efficiency of the resin current collector was lower than that of the metal current collector. On the other hand, in Example 1 and Example 2, although the resin current collector was used, the Coulomb efficiency was better than that of Comparative Example 2 and Comparative Example 3. In particular, in Example 2, a Coulombic efficiency as high as 89% was obtained.

What is claimed is:

1. A cell using a deposition-dissolution reaction of metallic lithium as an anode reaction, the cell comprising:
a cathode including a cathode current collector and a cathode active material layer;
an anode including at least an anode current collector; and
an electrolyte layer disposed between the cathode and the anode, wherein:
the anode current collector is a resin current collector; and
the anode includes a first metal layer between the anode current collector and the electrolyte layer, the first metal layer containing either or both of magnesium and silver.

2. The cell according to claim 1, wherein the anode includes a second metal layer between the anode current collector and the first metal layer, the second metal layer containing either or both of nickel and copper.

3. The cell according to claim 1, wherein the anode current collector and the first metal layer constitute a coated current collector.

4. The cell according to claim 1, wherein the first metal layer contains lithium.

5. The cell according to claim 1, wherein the first metal layer does not contain lithium.

6. The cell according to claim 1, wherein the electrolyte layer is a solid electrolyte layer containing a solid electrolyte.
